(19) United States
(12) Patent Application Publication
(10) Pub. No.: US 2014/0344682 A1
(43) Pub. Date: Nov. 20, 2014

(54) METHODS AND SYSTEMS FOR CUSTOMIZING TACTILELY DISTINGUISHABLE INPUTS ON A USER INPUT INTERFACE BASED ON AVAILABLE FUNCTIONS

(71) Applicant: United Video Properties, Inc., Santa Clara, CA (US)

(72) Inventors: Douglas J. Seyller, Lisle, IL (US); William J. Korbecki, Crystal Lake, IL (US); Thomas S. Woods, Arlington Heights, IL (US)

(73) Assignee: United Video Properties, Inc., Santa Clara, CA (US)

(21) Appl. No.: 13/896,856

(22) Filed: May 17, 2013

(51) Int. Cl. G06F 3/0484; G06F 3/01

(52) U.S. Cl. CPC G06F 3/0484; G06F 3/016
USPC 715/702

(57) ABSTRACT

Methods and systems are disclosed herein for a user input interface, which customizes tactilely distinguishable inputs on the user input interface based on available or currently in use functions on a target device. For example, a user input interface on a remote device (e.g., a tablet computer) may generate physical buttons associated with a function (e.g., adjusting volume) in response to determining that that function is available on a target device (e.g., a television, personal computer, or set-top box).

### BACKGROUND

Modern devices incorporate various user input types. For example, physical buttons, touchscreens, and motion controls are all commonly used. Each type of input has distinct advantages and drawbacks. A physical button is easier to operate and provides better input detection (e.g., the use feels the depression of the button into the use input interface indicating to the user the input was received) than a touchscreen. However, multiple physical buttons can clutter a user input interface, especially when many of the buttons do not relate to available or currently in use functions (e.g., DVD control buttons on a remote control when a user is watching broadcast television).

In contrast, a touchscreen may provide a less cluttered user input interface as only available or currently in use functions are displayed on the touchscreen at one time. For example, touching the same location on the touchscreen may cause different functions to occur depending on the icons currently displayed on the touchscreen. However, while, touchscreens often de-clutter a user input interface, touchscreens do not provide any tactilely distinguishable inputs. Consequently, touchscreens rely on visual (e.g., displaying confirmation screens or graphics on the user input interface) or audio indications (e.g., audio tones or clicks when the touchscreen is touched) to indicate a user input, which may be difficult for all users (e.g., disabled users, elderly users, or users viewing/listening to other devices) to understand or see/hear.

### SUMMARY OF THE DISCLOSURE

Accordingly, methods and systems are disclosed herein for a user input interface, which customizes tactilely distinguishable inputs on the user input interface based on available or currently in use functions on a target device. For example, a user input interface on a remote device (e.g., a tablet computer) may generate physical buttons associated with a function (e.g., adjusting volume) in response to determining that that function is available on a target device (e.g., a television, personal computer, or set top box). In some embodiments, generating physical buttons and/or tactilely distinguishable inputs may involve mechanically altering the height, surface texture, level of vibration, or surface temperature of the tactilely distinguishable inputs relative to the user input interface.

In some embodiments, a media application implemented on the device incorporating the user input interface, or on another device, may identify an input map, which determines the positions, types, and characteristics of tactilely distinguishable inputs on the user input interface. In some embodiments, the media application may cross-reference a current or available function with a database associated with potential input maps for the user input interface to select, one or more input maps. For example, in response to receiving a voice command requesting a volume control function, the media application may cross-reference the database to retrieve an input map featuring tactilely distinguishable inputs related to volume controls. Additionally or alternatively, input maps may also be selected based on various criteria such as conflicts between input maps or secondary factors such as user preferences and/or function importance.

In some embodiments, a media application may identify an input map, which determines the position of a tactilely distinguishable input on a user input interface, for performing a function, and may generate the first tactilely distinguishable input on the user input interface at the determined position. The media application also identifies another input map, which determines the position of another tactilely distinguishable input on the user input interface, for performing a different function, and may generate the other tactilely distinguishable input on the user input interface. The media application determines whether or not the tactilely distinguishable inputs conflict, and in response to determining a conflict, the media application removes one of the tactilely distinguishable input on the user input interface. Additionally or alternatively, if there is no conflict, the media application may generate the tactilely distinguishable inputs from both maps.

In some embodiments, the tactilely distinguishable inputs conflict when the tactilely distinguishable inputs are used to perform different functions. For example, a first tactilely distinguishable input may relate to one function (e.g., recording a media asset) and a second tactilely distinguishable input may relate to a second function (e.g., adjusting the brightness of a display screen). In order to reduce the number of different tactilely distinguishable inputs, the media application may provide only tactilely distinguishable inputs for a single function or a limited number of related functions.

Additionally or alternatively, conflicts may be determined based on the positions and/or numbers of the various tactilely distinguishable inputs. For example, tactilely distinguishable inputs may conflict when the positions of the tactilely distinguishable inputs overlap. For example, if two input maps both designate a particular location on the user input interface for a tactilely distinguishable input, which corresponds to different functions, the media application may determine a conflict. Additionally or alternatively, the media application may determine a conflict if the number of tactilely distinguishable inputs is above a threshold number. For example, the media application may limit the number of tactilely distinguishable inputs on a user input interface at any one time to ensure that the user input interface is intuitive to a user.

In some embodiments, the media application may generate the tactilely distinguishable input by defining a region at one position on a user input interface and modifying a height, surface temperature, level of vibration, surface texture and/or visual characteristics of the region with respect to an area on the user input interface outside the region. For example, the media application may generate, without user input, a tactilely distinguishable input on the user input interface at the first position by activating a mechanism that elevates a region at the first position with respect to the area outside the region on she user input interface, and the media application may remove, without user input, she tactilely distinguishable input on the user input interface by activating a mechanism that lowers the elevated region at the first position to align the elevated region, substantially parallel, with the area outside the region on the user input interface.

Additionally or alternatively, the media application may lock the area outside the region on she user input interface such that the area outside she region does not coincide with any functions to be performed using the user input interface. For example, a user input received at the area outside the region may not result in any function being performed (or may result in she generating of an error audio/visual indication). In some cases, locking the area outside the region may involve preventing a tactilely distinguishable input from being depressed or otherwise responding to a user input.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1A shows an illustrative example of a user device, which has generated a first plurality of tactilely distinguishable inputs on a user input interface, in which the first plurality of tactilely distinguishable inputs is associated with a first function in accordance with some embodiments of the disclosure;

FIG. 1B shows an illustrative example of a user device, which has generated a second plurality of tactilely distinguishable inputs on a user input interface, in which the second plurality of tactilely distinguishable inputs is associated with a second function in accordance with some embodiments of the disclosure;

FIG. 2 snows an illustrative example of a user device, which has generated a plurality of tactilely distinguishable inputs on a user input interface based on an input map in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows an illustrative example of a remote device, which has generated tactilely distinguishable inputs on a user input interface based on the current functions of a target device in accordance with some embodiments of the disclosure;

FIG. 6 is an illustrative example of a data structure that may be used by a media application to describe currently available functions of a target device in accordance with some embodiments of the disclosure;

FIG. 7 is a flowchart of illustrative steps for customizing tactilely distinguishable inputs on a user input interface based on available or currently in use functions in accordance with some embodiments of the disclosure; and

FIG. 8 is a flowchart of illustrative steps for selecting an input map for use in generating tactilely distinguishable inputs on a user input interface in accordance with some embodiments of the disclosure.

### DETAILED DESCRIPTION OF DRAWINGS

Methods and systems are disclosed herein for a user input interface, which customizes tactilely distinguishable inputs on the user input interface based on available or currently in use functions. For example, a media application implemented on a user device (e.g., a tablet computer), or remotely from a user device (e.g., on a server), may activate mechanisms within the user device to generate tactilely distinguishable inputs (e.g., buttons, joysticks, trackball, keypads, etc.) associated with a function available on the user device and/or another device (e.g., a television, personal computer, set-top box, etc.).

As used herein, a “tactilely distinguishable input” includes any input on a user input interface that is perceptible by touch. For example, a tactilely distinguishable input may include, but is not limited to, a region on a user input interface that is distinguished from other areas of the user input interface, such that a user can identify that the region is associated with the input, based on the height, surface temperature, level of vibration, surface texture and/or other feature noticeable to somatic senses. In addition, tactilely distinguishable inputs may also include visually distinguishing characteristics such as alphanumeric overlays, color changes or other graphic alterations or audio characteristics such a beeps, clicks, or audio overlays.

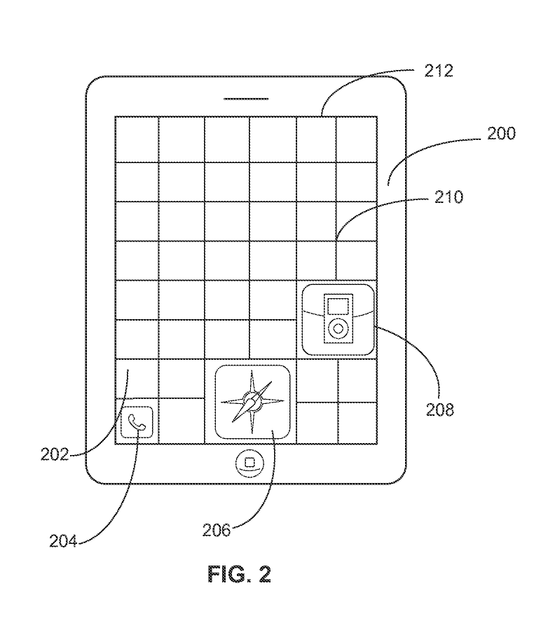

In some embodiments, the media application may activate mechanisms within the user device incorporating the user input interface to alter the physical dimensions and/or characteristics of a user input interface in order to generate tactilely distinguishable inputs for use in performing one or more functions. For example, in order to generate a button on the user input interface, the media application may generate appropriate forces (e.g., as described below in relation to FIG. 2) on a region of the user input interface associated with the button to elevate the region with respect to the area outside the region on the user input interface. Likewise, to remove the button, the media application may generate appropriate forces to lower the elevated region to align it, substantially parallel, with the area outside the region on the user input interface.

As used herein, an “input map” is a description of a layout of tactilely distinguishing inputs on a user input interface. For example, an input map may describe the size, shape, and/or position of tactilely distinguishing inputs on a user input interface. In some embodiments, the input map may also describe one or more of surface texture (rough or smooth), level of vibration (high or low), surface temperature (e.g., high or low, surface shape (e.g., extending a nub from the face of the input), or visual characteristics (e.g., glow, whether static or pulsing, or change color, with or without lighting) of a tactilely distinguishing input. In addition, these features may depend on the position of the input in the user input interface. For example, an input in the center of the user input interface may glow brighter than other inputs. Furthermore, the extent to which an input is tactilely distinguished may also depend on the input map or the position of the input in the user input interface. In some embodiments, tactile or visual distinction may also continue or increase until a user interacts with the input. For example, an input may vibrate until a user selects the input.

In some embodiments, an input map may include groups of functions. For example, an input map associated with standard television viewing may include both volume inputs and channel select inputs. For example, the input map may instruct a media application to generate a tactilely distinguishable input for both volume and channel select, when a media asset is being viewed.

In some embodiments, the input map may also describe the type of tactilely distinguishable input. For example, based on the function, the type of input may vary. For example, the media application may generate keypads when functions require entering alphanumeric characters. Additionally or alternatively, the media application may generate joysticks or control pads when functions require moving a selectable icon. In addition, the type of input may depend on the media asset. For example, the media application may generate joysticks or control pads when the media asset is a video game.

In some embodiments, the media application may generate an input map based at least in part on secondary factors. As used herein, “secondary factors” refer to criteria, other than currently accessible user equipment devices and currently available functions, used to select an input map. For example, secondary factors may include user preferences for particular functions or user equipment devices, likelihoods (e.g., based on prior use) that particular functions or user equipment devices will be used, level of importance of particular functions or user equipment devices (e.g., adjusting the brightness of a display screen of a device may be of less importance than adjusting the volume of the device), or any other information associated with a user that may be used to customize a display (e.g., whether or not the user has the dexterity or comprehension to use/understand particular input maps).

The tactilely distinguishable inputs may be used to perform functions related to media assets and/or devices. Functions may include, but are not limited to, interactions with media assets (e.g., recording a media asset, modifying the playback of the media asset, selecting media assets via a media guidance application, etc.) or user devices. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of she same. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television.

In some embodiments, a user device may incorporate a user input interface, and a user may use the user device to perform functions on the user device or another device. For example, the user device incorporating the user input interface (which, in some embodiments, may be referred to as a remote device), may be used to perform functions on a target device (which, in some embodiments, may refer to another use device).

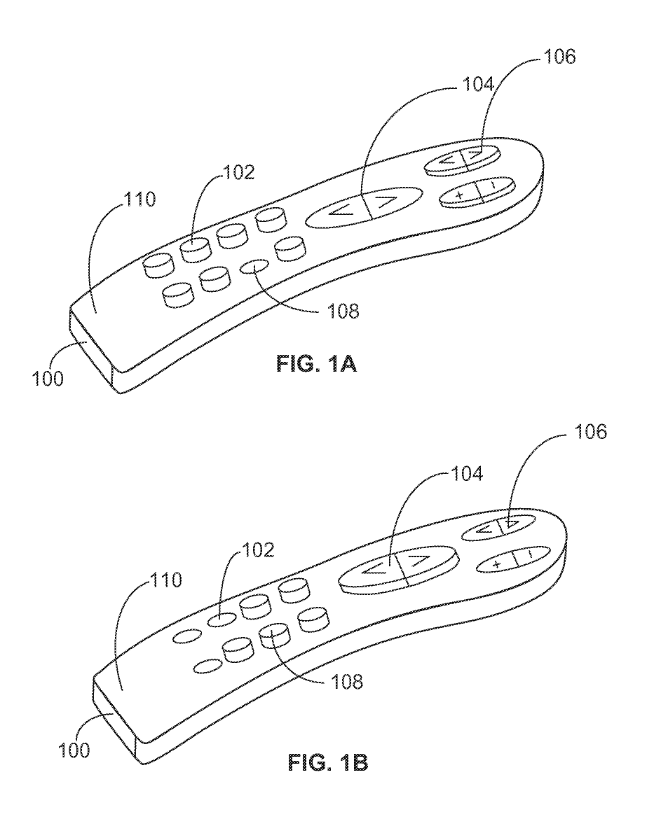

FIG. 1A shows an illustrative example of a remote device, which has generated a first plurality of tactilely distinguishable inputs on a user input interface, in which the first plurality of tactilely distinguishable inputs are associated with a first function in accordance with some embodiments of the disclosure.

User device 100, which, in some embodiments, may correspond to a remote control, includes inputs 102, 104, 106, and 108 on user input interface 110. In FIG. 1A, inputs 102 and 106 are currently raised (i.e., elevated with respect to user input interface 110). While raised, inputs 102 and 106 are tactilely distinguishable. For example, a user moving his/her fingers along user input interface 110 would feel that inputs 102 and 106 were elevated. In contrast, inputs 104 and 108 are currently lowered (i.e., substantially even with respect to user input interface). While lowered, inputs 104 and 108 are not tactilely distinguishable. For example, a user moving his/her fingers along user input interface 110 would feel inputs 104 and 103 as substantially flush with the user input interface. It should be noted that, in some embodiments, even lowered inputs may have some degree of tactile distinction. However, the amount of tactile distinction may be substantially less than that of raised inputs such that a user may, by there somatic senses, differentiate between the currently active inputs (e.g., input 102) and the currently inactive inputs (e.g., input 108).

In some embodiments, inputs 104 and 108 may also be raised and thus tactilely distinguishable based on functions currently available or currently in use on a target device as described in FIG. 1B below. For example, a media application implemented on a user device and/or a target device may indicate the functions (e.g., volume control, channel select, program recording, brightness control, etc.) currently available on a display screen of an associated device. Based on the available functions, the media application may determine whether or not a particular input (e.g., input 102) may be used. In response to determining that a particular input may be used, the media application may instruct user input interface 110 to tactilely distinguish the particular input. For example, the media application may instruct user input interface 110 to mechanically alter the height, surface texture, level of vibration, or surface temperature associated with the input.

For example, input 102 and input 106 may relate to functions for use when navigating a media guide. While a user is interacting with the media guide, input 102 and input 106 are tactilely distinguishable and active. For example, input 102 and input 106 may relate to navigation arrows for scrolling through the media guide.

In contrast, input 104 and input 108 may relate to functions for use when viewing a media asset (e.g., a pause and fast-forward feature). As the functions for use when viewing a media asset are not applicable to navigating a media guide, the media application may deactivate (e.g., lock) these inputs. Furthermore, the inputs may not be tactilely distinguishable.

However, after a user selects a media asset (e.g., via the media guide), input 102 and input 106 no longer relate to the currently available function (e.g., navigation arrows are not useful when viewing a media asset). In response, the media application may deactivate (e.g., lock) these inputs. Furthermore, the media application may remove the tactilely distinguishable features (e.g., may lower the elevated inputs to be substantially flush with the user input interface. In contrast, input 104 and input 108 may relate to functions for use when viewing a media asset (e.g., a pause and fast-forward feature), and are, therefore, activated and tactilely distinguished when the user views the media asset. Accordingly, the media application may instruct the user device and/or user input interface to raise input 104 and 108.

FIG. 1B shows an illustrative example of a remote device, which has generated a second plurality of tactilely distinguishable inputs on a user input interface, in which the second plurality of tactilely distinguishable inputs are associated with a second function in accordance with some embodiments of the disclosure.

In FIG. 1B, user device 100 also includes inputs 102, 104, 106, and 108 on user input interface 110. However, in contrast to FIG. 1A, inputs 102 and 106 are currently lowered, while inputs 104 and 108 are raised and thus tactilely distinguishable. For example, in FIG. 1B, a user may have performed an action that modified a display screen or a media asset associated user device 100. Accordingly, the functions currently available to a user have changed. In response to determining that the functions currently available to a user have changed, the media application has instructed user input interface 110 to adjust the inputs that are tactilely distinguishable. In FIG. 1B, inputs 108 and 104 now correspond to functions that are currently available, whereas inputs 102 and 106 are not currently available.

Additionally or alternatively, inputs 102 and 106 may correspond to redundant or less intuitive input layouts. For example, input 104 and 106 both correspond to up/down selection keypads (e.g., for use in scrolling through television channels). In FIG. 1A, input 106 is tactilely distinguishable and input 104 is not tactilely distinguishable, whereas in FIG. 1B, input 104 is tactilely distinguishable and input 106 is not tactilely distinguishable.

In some embodiments, the media application may determine (e.g., via input maps discussed below) the most efficient and intuitive layouts for inputs for available functions. In some cases, this may include removing redundant inputs as well as selecting the best input layouts for controlling currently available functions. For example, user input interface 110 may include multiple up/down selection keypads of various sizes (e.g., input 104 and input 106). In some input layouts, one of the multiple up/down selection keypads may be preferable. For example, if less inputs are currently needed (e.g., in some cases corresponding to less available functions), the media application may determine no tactilely distinguish larger inputs (e.g., input 104 instead of 106) in order to make selection of the inputs easier to a user. In contrast, if more inputs are currently needed (e.g., in some cases corresponding to more available functions), the media application may determine to tactilely distinguish smaller inputs (e.g., input 106 instead of 104) due to the space limitations of user input interface 110.

User input interface 110 may include multiple mechanisms for tactilely distinguishing each input. For example, the media application may, without user input, tactilely distinguish input 102 by instructing user input interface 110 to elevate a region associated with input 102 with respect to the area outside the region on user input interface 110. To elevate input 102, user input interface 110 may include one or more components (e.g., a spring, inflatable membrane, etc.) designed to impart an upward force from below input 102. In response to the application of the upward force, input 102 is extended away from user input interface 110. To lower input 102 (e.g., after determining a function associated with input 102 is no longer available), the media application may activate one or more components to oppose/reduce the upward force below input 102 (e.g., activating a hook to restrain the spring, activate deflation of the membrane, etc.). Additional methods for tactilely distinguishing an input are described in greater detail in Laitinen, U.S. Patent Pub. No. 2010/0315345, published Dec. 16, 2010, Pettersson, U.S. Patent Pub. No. 2009/0181724, published Jul. 16, 2009, Pettersson, U.S. Patent Pub, No. 2009/0195512, published Aug. 6, 2009, and Uusitalo et al. U.S. Patent Pub. No. 2008/0010593, published Jan. 10, 2008, each of which is hereby incorporated by reference in its entirety.

In some embodiments, the layout of the inputs may be determined based on an input map as discussed below in relation to FIG. 2.

FIG. 2 shows an illustrative example of a user device, which has generated a plurality of tactilely distinguishable inputs on a user input interface based on an input map in accordance with some embodiments of the disclosure. In FIG. 2, user device 200, which may correspond to a touchscreen tablet or smartphone, includes user input interface 212. User input interface 212 includes input grid 210. Input grid 210 defines a plurality of regions (e.g., region 202 and region 204) within user input interface 212 that may be used to generate tactilely distinguishable inputs (e.g., as discussed above) according to an input map.

Each tactilely distinguishable input (e.g. input 102 (FIG. 1)) may correspond to one or more regions (e.g., region 204) on user input interface 212. Furthermore, each region is associated with an area around the region, from which the input is tactilely distinguishable from. The area around a particular region is formed from adjacent regions in input grid 210 that are either not currently associated with an input or are associated with a different input. For example, region 204 is currently associated with a telephone function. Region 202 is not currently associated with the same telephone function (or any other function). Consequently, the media application may tactilely distinguish region 204 and region 202. Additionally, as region 202 is not currently associated with a function, the media application may lock region 202 such that a user input received at the location of region 202 would not produce an effect (or would result only in an audio/visual error notification).

It should be noted that in some embodiments, the regions of an input grid may include various shapes and sizes. For example, region 206 and region 208 are larger than region 202 and region 204. Additionally or alternatively, regions (as defined by input grid 210) may be combined to create larger regions. For example, in some embodiments, region 206 and region 208 may represent the combination of several smaller regions.

In FIG. 2, the media application has assigned inputs to the different regions within input grid 210. For example, region 204 is currently assigned to a telephone function. Region 206 is currently assigned to an Internet function, and region 208 is currently assigned to a music function. In some embodiments, regions 204, 206, and 208 may all correspond to various user equipment devices (e.g., as described below in relation to FIG. 4) that are accessible to a user from user device 200.

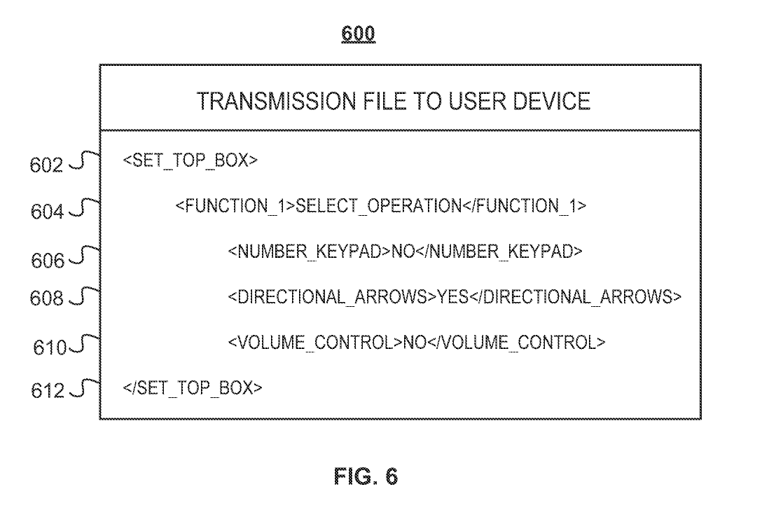

For example, the media application may allow a user to access and/or control one or more target devices (e.g., a television, personal computer, stereo, etc.) using a remote device (e.g., user device 200). In some embodiments, the media application may receive one or more data structures (e.g., data structure 600 (FIG. 6)) describing the available user equipment devices and functions that may be performed on each of the user equipment devices. Alternatively, regions 204, 206, and 208 may correspond co one or more functions of a single user equipment device. For example, a single user device (e.g., a computer) may currently have telephone, Internet, and music functions in use or available.

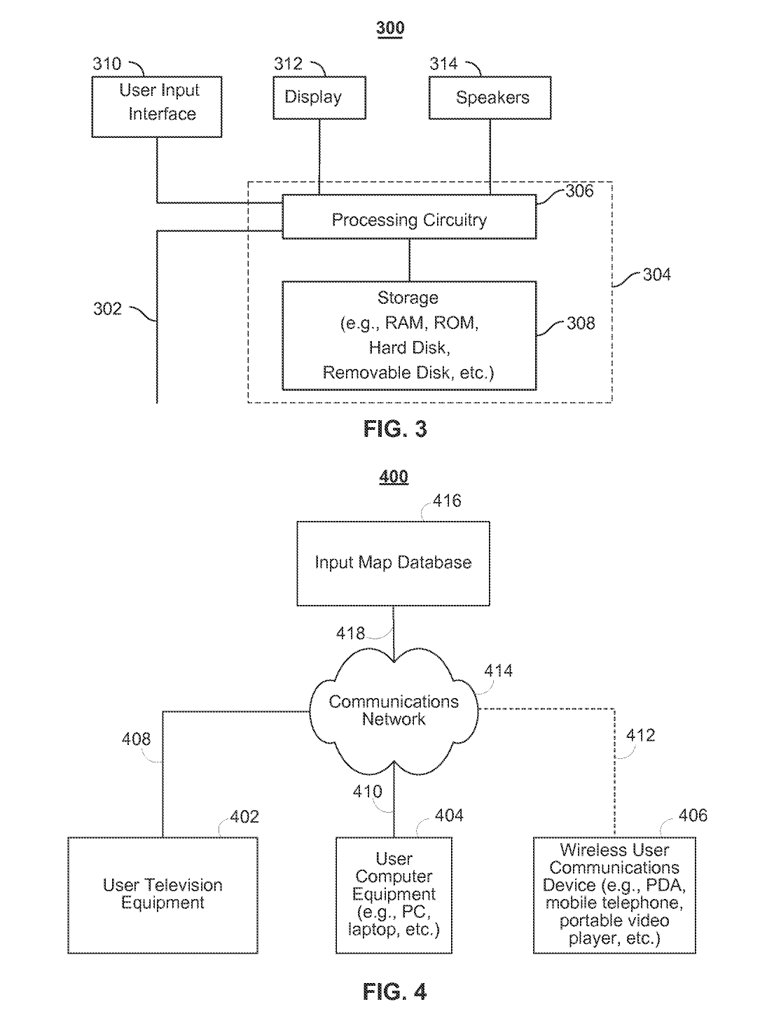

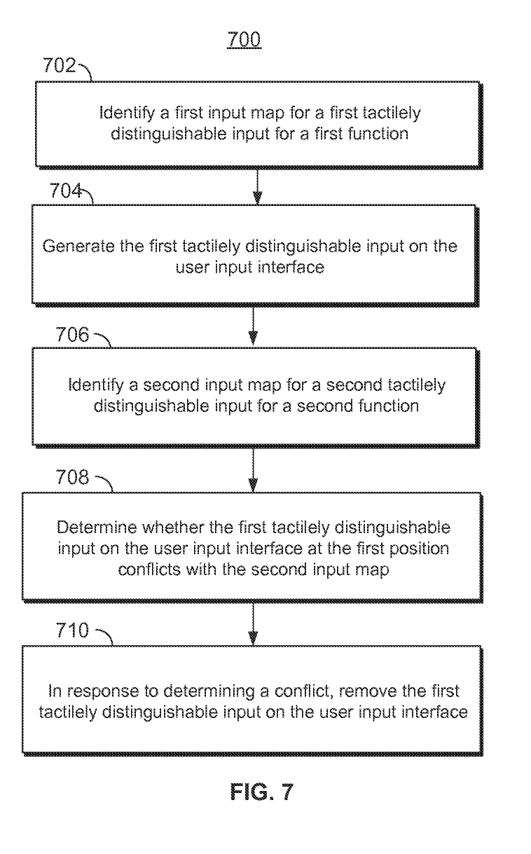

As described below in relation to FIG. 7, the media application may cross-reference the received available functions with a database of input maps to determine an input map for use on user input interface. 212. The media application (e.g., via control circuitry 304 (FIG. 3)) then generates (e.g., as described above in relation to FIG. 1) tactilely distinguishable inputs based on the determined input map. For example, the media application may instruct user input interface 212 or user device 200 to mechanically alter the height, surface texture, level of vibration, or surface temperature associated with a particular region in order to generate a tactilely distinguishable input.

To tactilely distinguish region 204 from the area around region 204, user input interface 212 may activate one or more components. For example, each region (e.g., region 202, 204, 206, and/or 208) may have one or more mechanisms associated with it. For example, an individual pressure sensitive membrane may be located under each region of input grid 210. Upon receipt of an instruction from the media application (e.g., via control circuitry 304 (FIG. 3)), the user input interface may pressurize the pressure sensitive membrane. The pressurization of the pressure sensitive membrane provides an upward force that causes the region (e.g., region 204) to extend away from user input interface 212.

Additionally or alternatively, each region (e.g., region 202, 204, 206, and/or 208) may have individual temperature variable components and vibration variable components. For example, an individual temperature variable component may be located under each region of input grid 210. Upon receipt of an instruction from the media application (e.g., via control circuitry 304 (FIG. 3)), user input interface 212 may transmit signals (e.g., an electrical charge) to electrically conductive components under a region (e.g., region 204) of input grid 210. The electrical stimulation may provide a temperature change or a change to the level of vibration of the region (e.g., region 204). Based on these changes, a user may now tactilely distinguish. (e.g., based on the difference in temperature or level of vibration) the region (e.g., region 204) from an area around the region (e.g., region 202).

Additionally or alternatively, each region (e.g., region 202, 204, 206, and/or 208) may also have various components for modifying the visual characteristics of each region. Upon receipt of an instruction from the media application (e.g., via control circuitry 304 (FIG. 3)), user input interface 212 may transmit instructions to adjust the color, brightness, alphanumeric characters, etc displayed in the region. For example, to identify a telephone function, region 204 includes an icon resembling a telephone. Based on these changes, a user may now visually distinguish the region (e.g., region 204) from an area around the region (e.g., region 202).

FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data (e.g., input maps from input map database 419 (FIG. 4)) to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood no mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiples of the same type of processing units (e.g., two Intel Core i7 processors) or multiple different processors (e.g., an Intel Core i5 processor and an Intel Core i7 processor). In some embodiments, control circuitry 304 executes instructions for a media application stored in memory (i.e., storage 308). Specifically, control circuitry 304 may be instructed by the media application to perform the functions discussed above and below. For example, the media application may provide instructions to control circuitry 304 to generate tactilely distinguishable inputs on a user input interface. In some implementations, any action performed by control circuitry 304 may be based on instructions received from the media application.

In client-server based embodiments, control circuitry 304 may include communications circuitry suitable for communicating with a server or other networks or servers. The instructions for carrying out the above mentioned functionality may be stored on the server. Communications circuitry may include a cable modem, an integrated services digital network (ISDN) modem, a digital subscriber line (DSL) modem, a telephone modem, Ethernet card, or a wireless modern for communications with other equipment, or any other suitable communications circuitry. Such communications may involve the Internet or any other suitable communications networks or paths (which are described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, FLU-RAY disc (BD) recorders, FLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content and data described herein. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations or such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content.

The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may include any suitable user interface, such as a remote control, mouse, trackball, keypad, keyboard, touch screen, touchpad, stylus input, joystick, voice recognition interface, or other user input interfaces. In addition, user input interface may include one or more components as described above and below for generating tactilely distinguishable inputs.

Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The media application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media application is a client-server based application. Data for use by a thick or thin client implemented on user equipment device 300 is retrieved on-demand by issuing requests to a server remote to the user equipment device 300. In one example of a client-server based media application, control circuitry 304 runs a web browser that interprets web pages provided by a remote server.

In some embodiments, the media application is downloaded and interpreted or otherwise run by an interpreter or virtual machine (run by control circuitry 304). In some embodiments, the media application may be encoded in the ETV Binary Interchange Format (EBIF), received by control circuitry 304 as part of a suitable feed, and interpreted by a user agent running on control circuitry 304. For example, the media application may be an EBIF application. In some embodiments, the media application may be defined by a series of JAVA-based files that are received and run by a local virtual machine or other suitable middleware executed by control circuitry 304. In some of such embodiments (e.g., those employing MPEG-2 or other digital media encoding schemes), the media application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment, user equipment devices and/or user devices, and may be substantially similar to user equipment devices described above. User equipment devices, on which a media application may be implemented, may function as a stand-alone device or may be part of a network of devices. Various network configurations of devices may be implemented and are discussed an more detail below.

In addition, any one of user equipment devices 402, 404, and 406 may incorporate a user input interface (e.g., user input interface 310 (FIG. 3)) to perform functions on any one of use equipment devices 402, 404, and 406. For example, any of user equipment devices 402, 404, and 406 may function as a remote device or a target device as explained above and below. Furthermore, a media application used to generate tactilely distinguishable inputs may be implemented on any of user equipment devices 402, 404, and 406, and may be used to generate tactilely distinguishable inputs on a user input interface on any of user equipment devices 402, 404, and 406.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may like some user television equipment 402, include a tuner allowing for access to television programming. The media application may have the same layout on various different types of user equipment or may be tailored to the display capabilities of the user equipment. For example, on user computer equipment 404, the media application may be provided as a web site accessed by a web browser. In another example, the media application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device. (e.g., user television equipment 402, user computer equipment 404, wireless user communications device 406) may be referred to as a. “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device. For example, in some embodiments, a remote device (e.g., user equipment device 406) may be used to perform functions on a target device (e.g., user equipment device 402).

The user may also set various settings to maintain consistent media application settings across in-home devices and remote devices. Settings include those described herein, as well as channel and program favorites, programming preferences that the media application utilizes to make programming recommendations, display preferences, and other desirable media settings. For example, if a user sets a channel as a favorite on, for example, the web site www.allrovi.com on their personal computer at their office, the same channel would appear as a favorite on the user's in-home devices (e.g., user television equipment and use computer equipment) as well as the user's mobile devices, if desired. Therefore, changes made on one user equipment device can change the media experience on another user equipment device, regardless of whether they are the same or a different type of user equipment device. In addition, the changes made may be based on settings input by a user, as well as user activity monitored by the media application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice, or data network (e.g., a 4G or LTE network), cable network, public switched telephone network, or other types of communications network or combinations of communications networks.

Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USE cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes also includes input map database 416 coupled to communications network 414 via communication path 418, respectively. Paths 418 may include any of the communication paths described above in connection with paths 408, 410, and 412.

Communications with input map database 416 may be exchanged over one or more communications paths, but are shown as a single path in FIG. 4 to avoid overcomplicating the drawing. In addition, there may be more than one of input map database 416, but only one of each is shown in FIG. 4 to avoid overcomplicating the drawing. If desired, user equipment devices 402, 404, and/or 406 and input map database 416 may be integrated as one device. Although communications between input map database 416 with user equipment devices 402, 404, and 406 are shown as through communications network 414, in some embodiments, input map database 416 may communicate directly with user equipment devices 402, 404, and 406 via communication paths (not shown) such as those described above in connection with paths 408, 410, and 412.

In some embodiments, data from input map database 416 may be provided to users equipment using a client-server approach. For example, a user equipment device may pull an input map from a server, or a server may push input map data to a user equipment device. In some embodiments, a media application client residing on the user's equipment may initiate sessions with input map database 416 to obtain input maps when needed, e.g., when the media application detects a new function is available. Input maps may be provided to the user equipment with any suitable frequency (e.g., continuously, daily, a user-specified period of time, a system-specified period, of time, in response to a request from user equipment, etc.). Input map database 416 may provide user equipment devices 402, 404, and 406 the media application itself or software updates for the media application.

Media applications may be, for example, stand-alone applications implemented on user equipment devices. For example, the media application may be implemented as software or a set of executable instructions which may be stored in storage 308, and executed by control circuitry 304 of a user equipment device 300. In some embodiments, media applications may be client-server applications where only a client application resides on the user equipment device, and server application resides on a remote server. For example, media applications may be implemented partially as a client application on control circuitry 304 of user equipment device 300 and partially on a remote server as a server application running on control circuitry of the remote server. When executed by control circuitry of the remote server, the media application may instruct the control circuitry to determine suitable input maps (e.g., as described in FIG. 6 below) and transmit the instructions for generating the input maps to the user equipment devices. In some embodiments, the server application may instruct the control circuitry of the input map database 416 to transmit data for storage on the user equipment. The client application may instruct control circuitry of the receiving user equipment to generate the tactilely distinguishable inputs.

Cloud resources may also be accessed by a user equipment device using, for example, a web browser, a media application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

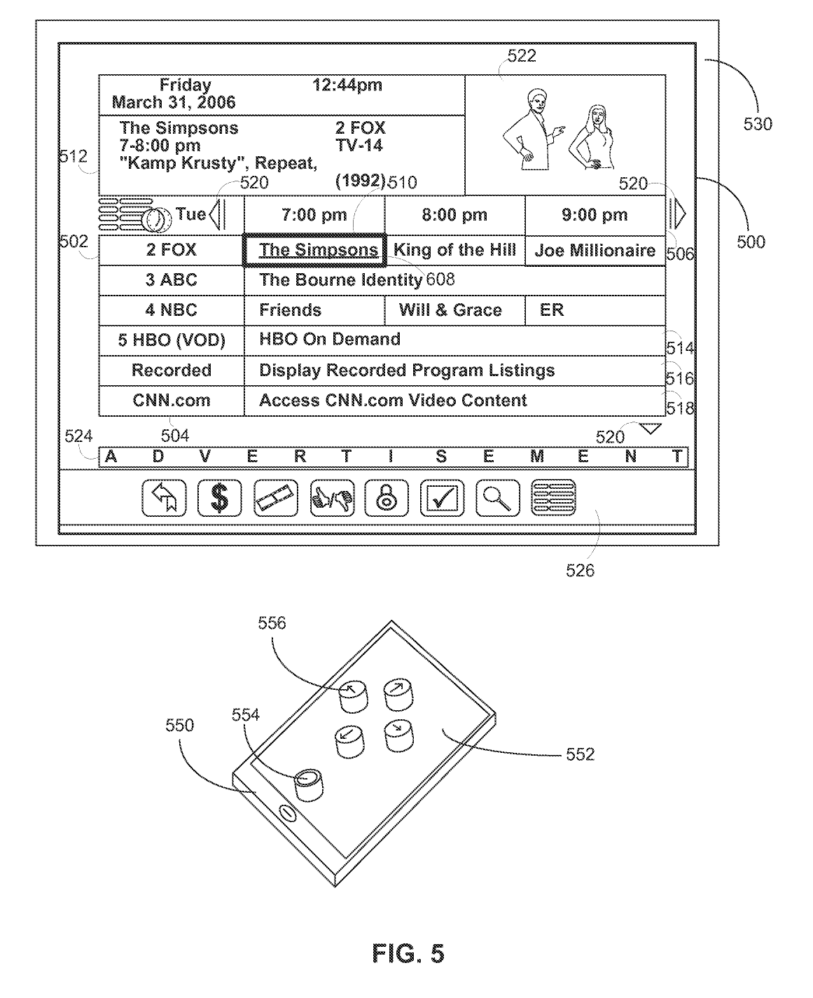

FIG. 5 shows an illustrative example of a remote device, which has generated tactilely distinguishable inputs on a user input interface based on the current functions of a target device in accordance with some embodiments of the disclosure. FIG. 5 shows display screen 500, which is being used to provide media assets to a user. Device 530, within which display screen 500 is implemented, may be any suitable user equipment device (e.g., user equipment device 402, 404, and/or 406 (FIG. 4)) or platform. Remote device 550 is currently being used by a user to perform functions on device 530. For example, remote device 550 is currently being used to select media assets for display on device 530.

For example, a user may indicate a desire to access content information by selecting a selectable option provided in a display screen (e.g., a menu option, a listings option, an icon, a hyperlink, etc.) on remote device 550. In response to the user's indication, display screen 500 may provide media assets organized in one of several ways, such as by time and channel in a grid.

Display screen 500 includes grid 502 with: (1) a column of channel/content type identifiers 504, where each channel/content type identifier (which is a cell in the column) identifies a different channel or content type available; and (2) a row of time identifiers 506, where each time identifier (which is a cell in the row) identifies a time block of programming. Grid 502 also includes cells of program listings, such as program listing 508, were each listing provides the title of the program provided on the listing's associated channel and time. With remote device 550, a user can select program listings by moving highlight region 510. Information relating to the program listing selected by highlight region 510 may be provided in program information region 512. Region 512 may include, for example, the program title, the program description, the time the program is provided (if applicable), the channel the program is on (if applicable), the program's rating, and other desired information.

Grid 502 also provides data for non-linear programming including on-demand listing 514, recorded content listing 516, and Internet content listing 518. A display combining data for content from different types of content sources is sometimes referred to as a “mixed-media” display.

Display screen 500 may also include video region 522, advertisement 524, and options region 526. Video region 522 may allow the user to view and/or preview programs that are currently available, will be available, or were available to the user. The content of video region 522 may correspond to, or be independent from, one of de listings displayed in grid 502. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media application display screens of the embodiments described herein.

Advertisement 524 may provide an advertisement for content that, depending on a viewer's a access rights (e.g., for subscription programming), is currently available for viewing, will be available for viewing in the future, or may never become available for viewing, and may correspond to or be unrelated to one or more of the content listings in grid 102. Advertisement 524 may also be for products or services related or unrelated to the content displayed in grid 502. Advertisement 524 may be selectable and provide further information about content, provide information about a product or a service, enable purchasing of content, a product, or a service, provide content relating to the advertisement, etc. Advertisement 524 may be targeted based on a user's profile/preferences, monitored user activity, the type of display provided, or on other suitable targeted advertisement bases.

While advertisement 524 is shown as rectangular or banner shaped, advertisements may be provided an any suitable size, shape, and location on display screen 500 and/or remote device 550. For example, advertisement 524 may be provided as a rectangular shape that is horizontally adjacent to grid 502. This is sometimes referred to as a panel advertisement. In addition, advertisements may be overlaid over content or a media application display or embedded within a display. Advertisements may also include text, images, rotating images, video clips, or other types of content described above. Advertisements may be stored in a user equipment device having a media application, in a database connected to the user equipment, in a remote location (including streaming media servers), or on other storage means, or a combination of these locations. Providing advertisements in a media application is discussed in greater detail in, for example, Knudson et al., U.S. Patent Application Publication No. 2003/0110499, filed Jan. 17, 2003; Ward, I I I an al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media application display screens of the embodiments described herein.

Remote device 550 includes several tactilely distinguishable inputs on user input interface 552. Input 556 is one of a set of inputs associated with scrolling and/or moving highlight region 510 about grid 502. Input 554 is associated with selecting content within highlight region 510. In some embodiments, remote device 550 may correspond to user device 100 (FIG. 1A-B) and/or user device 200 (FIG. 2-B). For example, in some embodiments, the positions of input 554 and input 556 may correspond to regions of an input grid (e.g., input grid 210 (FIG. 2)) associated with user input interface 552.

Furthermore, in some embodiments, a media application implemented on, or having access to, remote device 550 may have generated input 554 and input 556 in response to determining the current functions (e.g., navigating and selecting content, advertisements, or additional options) available to a user (e.g., as discussed below in relation to FIG. 7). For example, by cross-referencing a database (e.g., input map database 416 (FIG. 4)), the media application may have determined that the only functions currently in use or available (or most likely to be used by a user) based on the content currently displayed on display screen 500 is the navigation and selection of content, advertisements, or additional options. Furthermore, the retrieved input map may indicate the size, position, and type of tactilely distinguishably inputs for performing the functions (e.g., a set of inputs associated with moving highlight region 510 and selecting content within highlight region 510) currently in use or available to a user. In response, the media application (e.g., via control circuitry 304) may have transmitted instructions to user input interface 552 to generate input 554 and input 556.

In some embodiments, the media application may determine the functions that are currently in use or available to a user based on data received from device 530 about display screen 500. For example, device 530 may instruct the media application (e.g., implemented on remote device 550), as to which functions are currently an use or available. In some embodiments, the media application may receive this information in a data structure as discussed in relation to FIG. 6.

FIG. 6 is an illustrative example of a data structure that may be used by a media application to describe currently in use or available functions of a target device in accordance with some embodiments of the disclosure. For example, as described above, the media application determines the currently accessible user equipment devices and each of the currently available functions for those user equipment devices. In some embodiments, the media application accomplishes this by interpreting data structures received from various user equipment devices.

In some embodiments, a media application implemented on a remote device (e.g., remote device 550 (FIG. 5)) or a remote server (e.g., input map database 418 (FIG. 4)) may detect all currently accessible user equipment devices. In some embodiments, the media application may require a user to register the various devices with the media application. Additionally or alternatively, the media application may detect all devices on a network associated with a user (e.g., a home Wi-Fi network). The media application may then query each device to determine the currently available functions for those user equipment devices.

In response to a query from the media application, a user equipment device (e.g., device 530 (FIG. 5)) may transmit data structure 600. Data structure 600 includes numerous fields. Field 602 indicates the user equipment device (e.g., a set-top box) transmitting the data structure. Field 604 indicates a currently available function (e.g., a program select operation) associated with the user equipment device.

Data structure 600 also includes data on input types used with the currently available function. For example, field 606 indicates a number keypad is not used. Field 608 indicates that directional arrows are used. Field 610 indicates that volume controls are not used, and field 612 indicates the end of the currently available functions of the user equipment device.

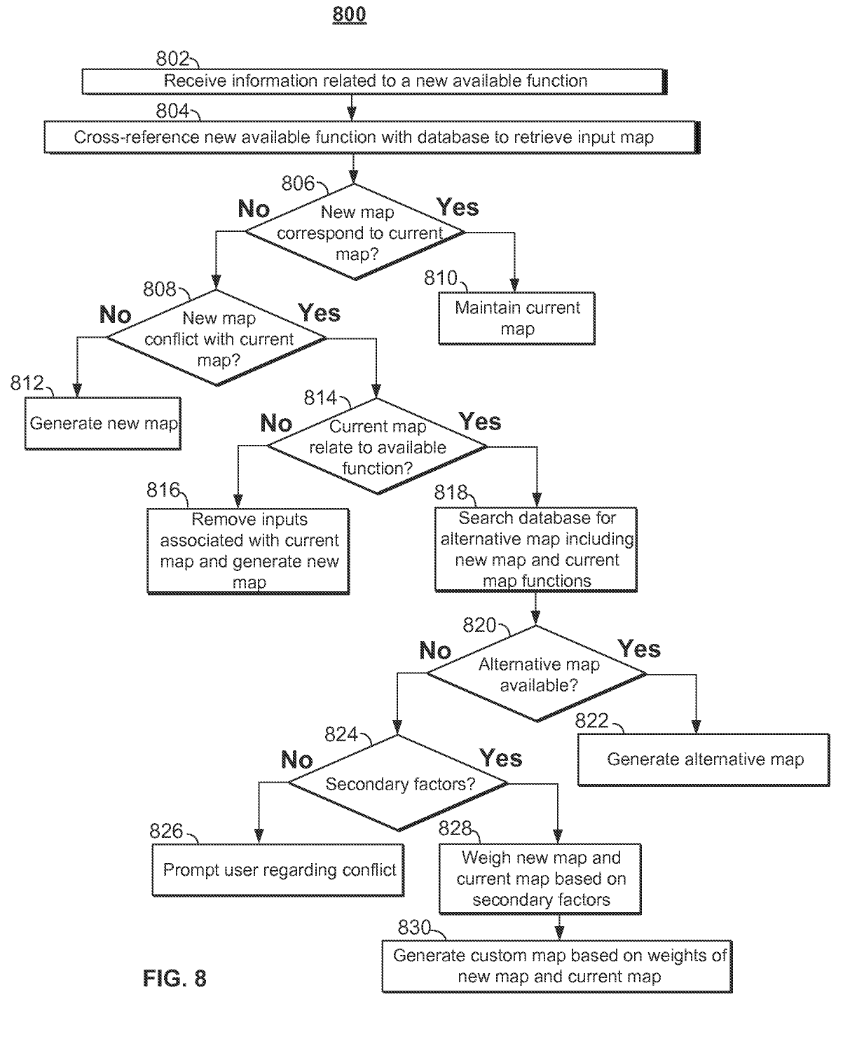

It should be noted that the information found in data structure 600 is illustrative only and that data structures, and the data contained within, received from various device may differ. For example, in some embodiments, data structures received from user equipment devices may include multiple functions. As described below in relation to FIG. 8, the media application may, in such cases, determine an input map in which controls for various functions do not conflict. In another example, a data structure received from a user device may not include data on input types used with the currently available function. For example, in some embodiments, the media application may receive only the currently available functions for a user equipment device. The media application may then have to cross-reference the currently available functions with a database located either remotely (e.g., input map database 416 (FIG. 4)) or locally (e.g., storage 308 (FIG. 3)) no determine input types used with the currently available function.

FIG. 7 is a flowchart of illustrative steps for customizing tactilely distinguishable inputs on a user input interface based on available or currently in use functions in accordance with some embodiments of the disclosure. Process 700 may be used to generate the tactilely distinguishable inputs shown and described in FIGS. 1A-B, 2, and 5 and/or generate/transmit the data structures as shown in FIG. 6. It should be noted that process 700 or any step thereof, could be performed by a media application implemented on any of the devices shown in FIGS. 3-4. For example, process 700 may be executed by control circuitry 304 (FIG. 3) as instructed by the media application.

At step 702, the media application identifies a first input map for a first tactilely distinguishable input for a first function. For example, in some embodiments, the media application may have received (e.g., via I/O path 302 (FIG. 3)) one or more data structures (e.g., data structure 600 (FIG. 6)) describing a currently accessible user equipment device (e.g., device 530 (FIG. 5)) and a currently available function thereon. The media application (e.g., via control circuitry 304 (FIG. 3)) may then cross-reference (e.g., as described below in relation to step 804 (FIG. 8)) the currently accessible user equipment device and the currently available function thereon with either a local (e.g., storage 308 (FIG. 3)) or remote (e.g., input map database 416 (FIG. 4)) to determine a first input map with a first tactilely distinguishable input for the currently available function.

As described in relation to FIG. 2, the first input map may provide instructions regarding the size, shape, and position of the first tactilely distinguishable input. In some embodiments, the size, shape, and position of the first tactilely distinguishable input may also depend on other tactilely distinguishable inputs. For example, as described in relation to FIG. 1, in some embodiments, the media application may determine the most efficient and intuitive layouts for tactilely distinguishable inputs for an available function. In some cases, this may include removing redundant tactilely distinguishable inputs as well as selecting the best input layouts for controlling currently available functions. The most efficient and/or intuitive layout may also be selected based on multiple secondary factors are described below in relation process 800 (FIG. 8).

At step 704, the media application generates the first tactilely distinguishable input on the user input interface. For example, based on the first user input map, the media application (e.g., via control circuitry 304 (FIG. 3)) instructs the user input interface (e.g., user input interface 110 (FIG. 1) or user input interface 212 (FIG. 2)) to generate tactilely distinguishable inputs for use in performing the first function. For example, the media application may assign particular regions (e.g., region 204 (FIG. 2)) of the user input interface (e.g. user input interface 212 (FIG. 2)) to particular functions.

The media application may then transmit instructions (e.g., via control circuitry 304 (FIG. 3)) to tactilely distinguish the region (e.g., region 204 (FIG. 2)) from the area around the region (e.g., region 202 (FIG. 2)) on the user input interface (e.g., user input interface 212 (FIG. 2)) as discussed above.

At step 706, the media application identifies a second input map for a second tactilely distinguishable input for a second function. For example, in some embodiments, the media application may have received (e.g., via I/O path 302 (FIG. 3)) additional data structures (e.g., data structure 600 (FIG. 6)) updating the currently accessible user equipment device (e.g., device 530 (FIG. 5)) and the currently available function thereon. In some embodiments, these additional data structures are received periodically, continuously (e.g., in real-time), or in response to a user input received at either the user input interface (e.g., user input interface 552 (FIG. 5) of a remote device (e.g., remote device 550 (FIG. 5)) or a target device (e.g., device 530 (FIG. 5)). For example, in response to an instruction to perform a first function at the target device, the media application may automatically call the target device for updated data structures describing a second function. For example, as described in relation to FIG. 1, the selection of a media asset from a media guide may cause the media application to automatically call the target device regarding the status (e.g., whether or no the media asset is currently being presented) of the media assets.

The media application (e.g., via control circuitry 304 (FIG. 3)) may then cross-reference (e.g., as described below in relation to step 804 (FIG. 8)) the currently accessible user equipment device and the currently available function thereon with either a local (e.g., storage 308 (FIG. 3)) or remote (e.g., input map database 416 (FIG. 4)) no determine a second input map with a second tactilely distinguishable input for the second function.

At step 708, the media application determines whether the first tactilely distinguishable input on the user input interface at the first position conflicts with the second input map (e.g., as described below in relation to process 800 (FIG. 8)). In some embodiments, the tactilely distinguishable inputs conflict when the tactilely distinguishable inputs are used to perform different functions. For example, a first tactilely distinguishable input may relate to one function (e.g., recording a media asset) and a second tactilely distinguishable input may relate to a second function (e.g., adjusting the brightness of a display screen). In order to reduce, the number of different tactilely distinguishable inputs, the media application may provide only tactilely distinguishable inputs for a single function or a limited number of related functions. By minimizing the number of tactilely distinguishable inputs (e.g., input 102 (FIG. 1A), or the number of functions that may be performed at any one time, on the user input interface (e.g., user input interface 110 (FIG. 1A)), the media application may simplify user interactions with the user input interface. By simplifying the use interactions, the media application reduces the frequency and amount of erroneous inputs.

Additionally or alternatively, the media application may determine a conflict if the number of tactilely distinguishable inputs or available functions is above a threshold number (e.g., five inputs or functions at one time). For example, the media application may limit the number of tactilely distinguishable inputs on a user input interface at any one time to ensure that the user input interface is intuitive to a user. In such cases, the media application (e.g., via control circuitry 304 (FIG. 3)) may compare the number of tactilely distinguishable inputs or available functions currently on the user input interface (e.g., user input interface 552 (FIG. 5)) to a threshold number. The threshold number may be retrieved from a local (e.g., storage 308 (FIG. 3)) or remote (input map database 416 (FIG. 4)) database.

Additionally or alternatively, conflicts may be determined based on the positions and/or numbers of the various tactilely distinguishable inputs. For example, tactilely distinguishable inputs may conflict when the positions of the tactilely distinguishable inputs overlap. For example, if two input maps both designate a particular location (e.g., region 204 (FIG. 2)) on the user input interface (e.g., use input interface 212 (FIG. 2)) for a tactilely distinguishable input which corresponds to different functions, the media application may determine a conflict.

At step 710, the media application removes the first tactilely distinguishable input on the user input interface in response to determining a conflict. For example, in response to determining that the number of tactilely distinguishable inputs or available functions currently on the user input interface is above the threshold or that the first and second input map both designate a particular position (e.g., region (FIG. 2)) for different tactilely distinguishable inputs, the media application may remove one or more tactilely distinguishable inputs or available functions. Additionally or alternatively, the media application may search a database for alternative input maps (e.g., as described in relation to step 818 (FIG. 3)).

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

FIG. 8 is a flowchart of illustrative steps for selecting an input map for use in generating tactilely distinguishable inputs on a user input interface in accordance with some embodiments of the disclosure. Process 800 may be used to generate the tactilely distinguishable inputs shown and described in FIGS. 1A-B, 2, and 5 and/or generate/transmit the data structures as shown in FIG. 6. It should be noted that process 800 or any step thereof, could be performed by a media application implemented on any of the devices shown in FIGS. 3-4. For example, process 800 may be executed by control circuitry 304 (FIG. 3) as instructed by the media application.

At step 802, the media application receives information related to a new available function. In some embodiments, upon initiation, the media application implemented on a remote device (e.g., remote device 550 (FIG. 5)) or a remote server (e.g., input map database 418 (FIG. 4)) may detect all currently accessible user equipment devices (e.g., user equipment devices 402, 404, and/or 406 (FIG. 4)) accessible by a network (e.g., communications network 414 (FIG. 4)). In some embodiments, the media application may detect all devices on a network associated with a user (e.g. a home Wi-Fi network). In some embodiments, the media application may require a user to register various devices with the media application. The media application may then query each device to determine the currently available functions for those user equipment devices.

In response to the query, the media application receives information related to a new available function. For example, in some embodiments, the media application may have received (e.g., via I/O path 302 (FIG. 3)) one or more data structures (e.g., data structure 600 (FIG. 6)) describing a currently accessible user equipment device (e.g., device 530 (FIG. 5)) and/or a currently in use or available function thereon.

Additionally or alternatively, the media application may receive a command related to a different function other than functions indicated in a data structure. For example, the command may be issued by a user (e.g., a vocal command) or by another user device (e.g., a recording/viewing reminder).

At step 804, the media application cross-references the new available function in a database to retrieve an input map. For example, the media application (e.g., via control circuitry 304 (FIG. 3)) may cross-reference the currently available function with either a local (e.g., storage 308 (FIG. 3)) or remote (e.g., input map database 416 (FIG. 4)) to determine an input map with a tactilely distinguishable input for the currently available function.

In some embodiments, the database may be structured as a lookup table database. The media application may enter criteria in addition to the currently available function, which is used to filter the available input maps. For example, the input map may be tailored to a particular user based on a user profile. For example, the media application may store (e.g., in storage 308 (FIG. 3)) information about use preferences or about past uses (e.g., input maps that a user is familiar with). Based on the information in the user profile, the media application may select a particular input map.

At step 806, the media application determines whether or not the new map corresponds to a current input map. For example, in some embodiments, the media application receives (e.g., via I/O path 302 (FIG. 3)) data structures (e.g., data structure 600 (FIG. 6)) describing the currently accessible user equipment device (e.g., device 530 (FIG. 5)) and the currently available function thereon. In some embodiments, these additional data structures are received periodically, continuously (e.g., in real-time), or in response to a user input received at either the user input interface (e.g., user input interface 552 (FIG. 5) of a remote device (e.g., remote device 550 (FIG. 5)) or a target device (e.g., device 530 (FIG. 5)). Depending on the amount of time, or the user actions performed, if any, between the receipt of data structures, the currently available functions, and, in some cases, the input map associated with those functions may not have changed.

If the media application determines that the new map corresponds to the current input map, the media application maintains the current map at step 810. If the media application determines chat the new map does not correspond to the current input map, the media application (e.g., via control circuitry 304 (FIG. 3)) determines whether or not the new map conflicts with the current map at step 808. For example, each input map may assign various tactilely distinguishable inputs to various positions (e.g., region 204 (FIG. 2)) of a user input interface (e.g., user input interface 212 (FIG. 2)). As described in process 700 (FIG. 7), the media application may determine a conflict based on various conditions.

If the media application determines that the new map does not conflict with the current map at step 808, the media application generates the new map at step 812. In some embodiments, generating the new map may include overlaying the new map on the current map. In such cases, the user input interface (e.g., user input interface 212 (FIG. 2)) may include tactilely distinguishable inputs based on both the current map and the new map. If the media application determines that the new map does conflict with the current map at step 808, the media application determines whether or not the current map relates to an available function at step 814.

For example, as information is received by the media application in step 802, the previously available functions may no longer be available. For example, additional data structure received periodically, continuously (e.g., in real-time), or in response to a user input received at either the user input interface (e.g., user input interface 552 (FIG. 5) of a remote device (e.g., remote device 550 (FIG. 5)) or a target device (e.g., device 530 (FIG. 5)) may indicate that functions were performed that changed the currently available functions. For example, a user may have selected program listing 508 (FIG. 5) of grid 502 (FIG. 5)). In response, the media application may replace grid 502 (FIG. 5) with a media asset associated with program listing 508 (FIG. 5). As grid 502 (FIG. 5) is no longer displayed, functions related to movement about grid 502 (FIG. 5) may no longer be accessible. For example, in response to a selection of program listing 508 (FIG. 5), a data structure describing the current status (e.g., the currently available functions) of display screen 500 (FIG. 5) on device 530 (FIG. 5)) may be received by the media application.

If the current map no longer relates to available functions, the media application removes the tactilely distinguishable inputs associated with the current map and generates the new map at step 816. For example, the media application may activate (e.g., via control circuitry 304 (FIG. 3)) one or more components to oppose/reduce the upward force that resulted in the generation of the tactilely distinguishable input of the current map as described above (e.g., activating a hook to restrain a deployed spring, activate deflation of a pressurized membrane, etc.). If the current map still relates to available functions, the media application searches a database (e.g., input map database 416 (FIG. 4)) for alternative maps, which include the new map and the current map functions at step 818.

For example, although the new map and current map may conflict, the media application may determine (e.g., via control circuitry 304 (FIG. 3)) that an alternative map may resolve the conflict. For example, the media application may determine the conflict is based on the number of tactilely distinguishable inputs or available functions being above a threshold number (e.g., five inputs or functions au one time). In such cases, the media application (e.g., via control circuitry 304 (FIG. 3)) may compare the tactilely distinguishable inputs or available functions currently on each map to determine whether or not the tactilely distinguishable inputs or available functions may be combined such that the number of tactilely distinguishable inputs or available functions is below the threshold number. In some embodiments, combining the tactilely distinguishable inputs or available functions may include retrieving an alternate map that includes both the new map and current map functions from a local (e.g., storage 308 (FIG. 3)) or remote (input map database 416 (FIG. 4)) database.

Additionally or alternatively, conflicts may be determined based on the positions of the various tactilely distinguishable inputs. For example, tactilely distinguishable inputs may conflict when the positions of the tactilely distinguishable inputs overlap. For example, if two input maps both designate a particular location (e.g., region 204 (FIG. 2)) on the user input interface (e.g., use input interface 212 (FIG. 2)) for a tactilely distinguishable input, which corresponds to different functions, the media application may determine a conflict. In some embodiments, resolving this conflict includes retrieving an alternate map, which includes both the new map and current tactilely distinguishable inputs in different positions, from a local (e.g., storage 308 (FIG. 3)) or remote (input map database 416 (FIG. 4)) database.

At step 820, the media application determines whether or not an alternative input map is available. For example, the media application determines whether or not there is an alternative input map that resolves the conflict. If the media application determines that an alternative input map is available, the media application generates the alternative input map at step 822. If the media application determines that an alternative input map is not available, the media application proceeds to step 824.

At step 824, the media application determines whether or not there are any secondary factors for use in selecting an input map. For example, the input map may be selected for a particular user based on a user profile. If the media application determines that there are not any secondary factors for use in selecting an input map, the media application prompts the user regarding the conflict. For example, the media application may generate an error message, pop-up notification, etc requesting that the user resolve the conflict (e.g., by selecting an input map, tactilely distinguishable input, or functions).

In some embodiments, following a prompt, the media application may allow a user to generate a custom map. For example, the media application may receive a user request for tactilely distinguishable feature. In addition, the user request may include size, shape, and position information (or other information associated with an input map). Based on the user request, the media application may generate a custom input map. The media application may then transmit instructions to the user input interface to generate tactilely distinguishable inputs based on the custom input map. In some embodiments, the media application may not need to prompt the user in order for the user to generate a custom map. For example, in some embodiments, the custom maps may be created and stored (e.g., on storage 308 (FIG. 3)) on the user device. The custom map may also be associated with a particular user profile. In addition, in some embodiments, a use may determine the functions that are associated with the custom map. For example, when a particular function becomes available, the custom map may be retrieved instead of another predefined map.

If the media application determines that there are secondary factors for use in selecting an input map, the media application uses the secondary factors to weigh the new map and the current map at step 828.

At step 830, the media application generates a custom map based on the weights given to the new map and the current map. For example, the media application may store (e.g., in storage 308 (FIG. 3)) information about user preferences or about past uses (e.g., input maps that a user is familiar with) to determine what functions are more likely to be used. For example, if the media application determines that a particular function is unlikely to be selected, the media application may resolve a conflict by searching for an alternative input map without that function or by removing the function from the current or new input map. Alternatively or additionally, if the media application determines that a particular function is likely to be selected, the media application may resolve a conflict by maintaining that function and/or removing another function from the current or new input map.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method of customizing tactilely distinguishable inputs on a user input interface, the method comprising:
identifying a first input map for performing a first function, wherein the first input map determines a first position of a first tactilely distinguishable input on the user input interface;
generating the first tactilely distinguishable input on the user input interface at the first position;
identifying a second input map for performing a second function, wherein the second input map determines a second position of a second tactilely distinguishable input on the user input interface;
determining whether the first tactilely distinguishable input on the user input interface at the first position conflicts with the second input map; and
in response to determining a conflict, removing the first tactilely distinguishable input on the user input interface.

2. The method of claim 1, further comprising, in response to determining no conflict, generating the second tactilely distinguishable input on the user input interface at the position in addition to the first tactilely distinguishable input on the user input interface at the first position.

3. The method of claim 1, wherein the first tactilely distinguishable input conflicts with the second input map when the first tactilely distinguishable input is not used to perform the second function.

4. The method of claim 1, wherein the first tactilely distinguishable input conflicts with the second input map when the second position overlaps the first position.

5. The method of claim 1, wherein the first tactilely distinguishable input conflicts with the second input map when a number of tactilely distinguishable inputs on the user input interface is above a threshold number.

6. The method of claim 1, wherein generating the tactilely distinguishable input further comprises:
defining a region at the first position; and
modifying a height, surface temperature, level of vibration, or surface texture of the region with respect to an area outside the region on the user input interface.

7. The method of claim 1, further comprising locking the area outside the region on the user input interface such that the area outside the region does not coincide with any functions to be performed using the user input interface.

8. The method of claim 1, further comprising selecting the first function based on a vocal command issued by a user.

9. The method of claim 1, further comprising:
generating, without user input, the first tactilely distinguishable input on the user input interface at the first position by elevating a region at the first position with respect to an area outside the region on the user input interface; and
removing, without user input, the first tactilely distinguishable input on the user input interface by lowering the elevated region at the first position to align the elevated region, substantially parallel, with the area outside the region on the user input interface.

10. The method of claim 1, wherein generating the tactilely distinguishable input further comprises:
defining the region at the first position; and
visually distinguishing the region with respect to an area outside the region on the user input interface.

11. A system of customizing tactilely distinguishable inputs on a user input interface, the system comprising control circuitry configured to:
identify a first input map for performing a first function, wherein the first input map determines a first position of a first tactilely distinguishable input on the user input interface;
generate the first tactilely distinguishable input on the user input interface at the first position;
identify a second input map for performing a second function, wherein the second input map determines a second position of a second tactilely distinguishable input on the user input interface;
determine whether the first tactilely distinguishable input on the user input interface at the first position conflicts with the second input map; and
in response to determining a conflict, remove the first tactilely distinguishable input on the user input interface.

12. The system of claim 11, further comprising control circuitry configured to generate the second tactilely distinguishable input on the user input interface at the position in addition to the first tactilely distinguishable input on the user input interface at the first position in response to determining no conflict.

13. The system of claim 11, wherein the first tactilely distinguishable input conflicts with the second input map when the first tactilely distinguishable input is not used to perform the second function.

14. The system of claim 11, wherein the first tactilely distinguishable input conflicts with the second input map when the second position overlaps the first position.

15. The system of claim 11, wherein the first tactilely distinguishable input conflicts with the second input map when a number of tactilely distinguishable inputs on the user input interface is above a threshold number.

16. The system of claim 11, wherein generating the tactilely distinguishable input further comprises:
defining a region at the first position; and
modifying a height, surface temperature, level of vibration, or surface texture of the region with respect to an area outside the region on the user input interface.

17. The system of claim 11, further comprising control circuitry configured to lock the area outside the region on the user input interface such that the area outside the region does not coincide with any functions to be performed using the user input interface.

18. The system of claim 11, further comprising control circuitry configured to select the first function based on a vocal command issued by a user.

19. The system of claim 11, further comprising control circuitry configured to:
generate, without user input, the first tactilely distinguishable input on the user input interface at the first position by elevating a region at the first position with respect to an area outside the region on the user input interface; and
remove, without user input, the first tactilely distinguishable input on the user input interface by lowering the elevated region at the first position to align the elevated region, substantially parallel, with the area outside the region on the user input interface.

20. The system of claim 11, wherein generating the tactilely distinguishable input further comprises:
defining the region at the first position; and
visually distinguishing the region with respect to an area outside the region on the user input interface.

21-40. (canceled)
